(19) United States
(12) Patent Application Publication
(10) Pub. No.: US 2014/0137344 A1
(43) Pub. Date: May 22, 2014

(54) Electrical toothbrush

(71) Applicant: Ronald Chaccour, Zgharta (LB)

(72) Inventor: Ronald Chaccour, Zgharta (LB)

(21) Appl. No.: 13/681,429

(22) Filed: Nov. 20, 2012

(51) Int. Cl. A61C 17/22

(52) U.S. Cl. CPC A61C 17/222
USPC 15/21.1

(57) ABSTRACT

This toothbrush is designed to brush our teeth in a short period of time and in an effective way.

This invention is an electrical motorized toothbrush (FIG. 11). It has four main components: an electric motor (FIG. 1), a flexible plastic (rubber or silicone) brush holder (FIG. 2), 3 rotative brushes (FIG. 8), and a tongue cleaner (FIG. 10).
3 differentials pass the rotative motion of the electric motor to the 3 brushes (FIG. 2, 7).
The electric motor is any standard 12V or (220-110V) motor used in small electrical tools and machinery such as shaving machine, hair trimmers, and electrical toothbrush with strong motor.
The 3 brushes are made of hollow flexible plastic tubes and covered by synthetic bristles the same used in normal toothbrushes (FIG. 6). The tubes of the brushes have almost the same structure of the joint of a straw (FIG. 6), the structure of several rings following each other in a plastic tube gives a comfortable rotational move to the bent plastic tubes.
The brush holder is made of flexible fiber or any other flexible material and has the shape of a dental impression tool (FIG. 2).
The brush of the chewing side of the teeth sits lower in the holder than the 2 others (FIG. 8). The 3 brushes together form a powerful cleaning tool, since they cover the entire surface to be cleaned of a tooth (FIG. 8).
A main shaft connects the motor motion to each brush by the mean of a differential (FIG. 2). Two superposed gears transmit the motion of the main shaft to the differentials of the inner brush and outer brush (FIG. 4, 3) and the shaft passes through the third brushes differential (FIG. 5).
The differentials are covered by the tubes of the brushes and they consist of 1 pinion and 2 similar ring gears (FIG. 4). The ring gears are connected to the tubes by the means of 2 inner axis (FIG. 7).
The brush holder can have different sizes but a good study of human (or animal) dental impressions in a simulator (software . . . ) can reduce the number of holders' and brushes sizes the company have to offer to a few (3 to 6 measures).

The motor kit can be unique and any holder of different size can be fixed to it.
The tongue cleaner is a mobile part and can be fixed at the end of the borders (FIG. 10).

### BENEFITS OF THE DEVICE

This new brush with its ease and being a new gadget help youngsters have more interest in mouth care and so it will help growing healthier generations.

Its good impact on health will lead to a good impact on social security monetary funds, decreasing the amounts to be paid.

Flexible, it fits in everybody's mouth easily. Three main sizes required to fulfill everybody's need of a suitable brush. Most of dental mouth measurement tools come in three main sizes. The number of suitable sizes offered can be greater, and a good promotion can be made upon this issue by offering paper or nylon molds in order to get your dental impression and so choosing the best suitable size following your dental impression.

Rotating power: the rotational action of the three brushes of this toothbrush is very effective. Rotational cleaning has proven itself to be highly effective especially in the carwash industry. Almost every carwash machine has a rotational move.

Mass production of this toothbrush and the competition among the companies promoting it will decrease its production price and therefore its selling price making the device very popular everywhere else in the world.

When sold at low prices, humanity will appear as a better race, with higher motives, good moods, and a more shiny energy on the face of everyone.

The sales of this new item will have good impact on global economy since it's a new useful item to buy. Indeed a new product in the markets always makes the good economy run.

The good effect on the bad breath we all have to deal with (sorry to say it) will help socializing and encourage people close contact. This also will have a good influence on the global economy.

This item is a long term investment for the companies adopting its production since it's meant to be a world wide used item and the need to change the three brushes consisting its cleaning part is a good source for spare parts selling and manufacturing. Another importance is that this item constitutes a good field for innovation in all the parts consisting it.

### BRIEF DESCRIPTION OF THE DRAWINGS

FIG. 1 shows the electric motor

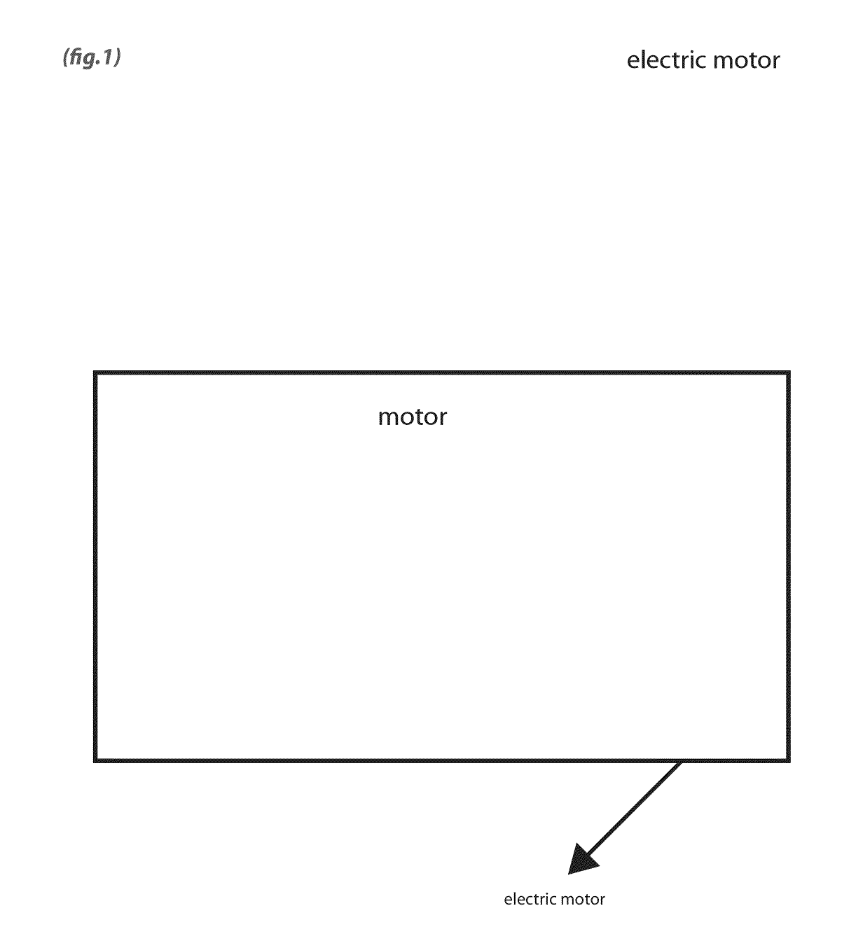

FIG. 2 shows the upper view of the brush holder

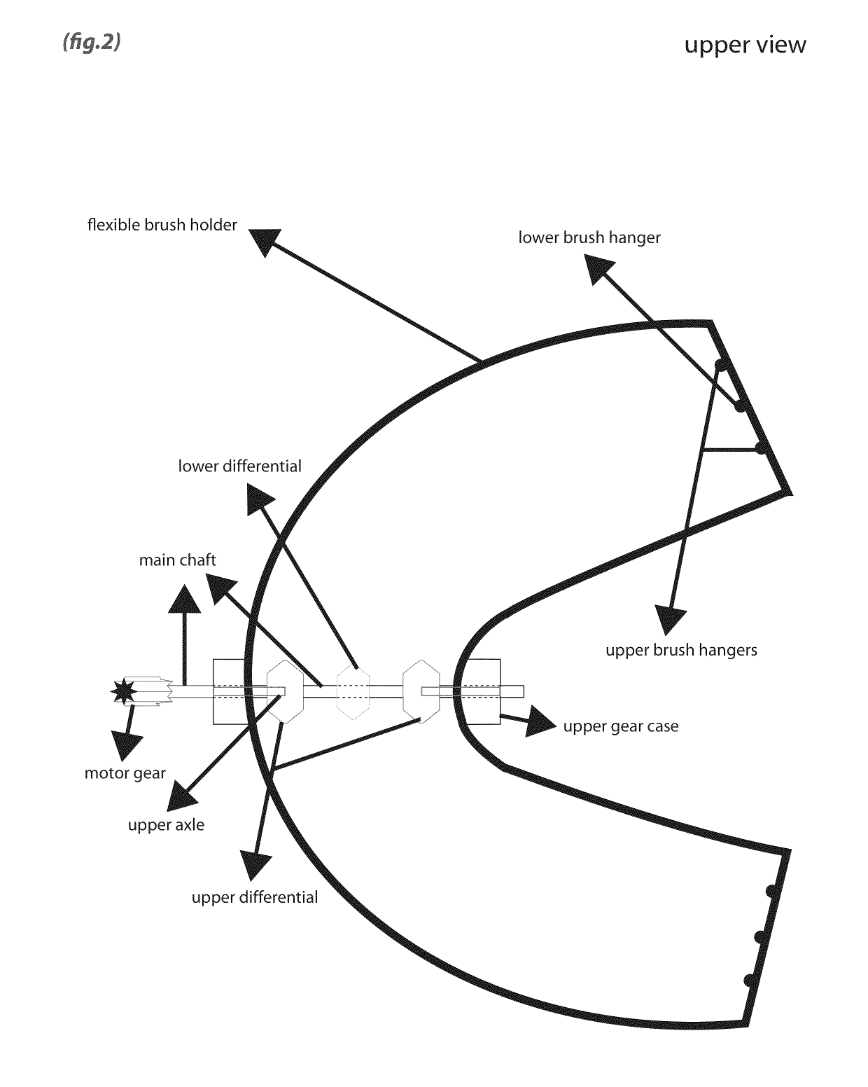

FIG. 3 shows the side view of the brush holder

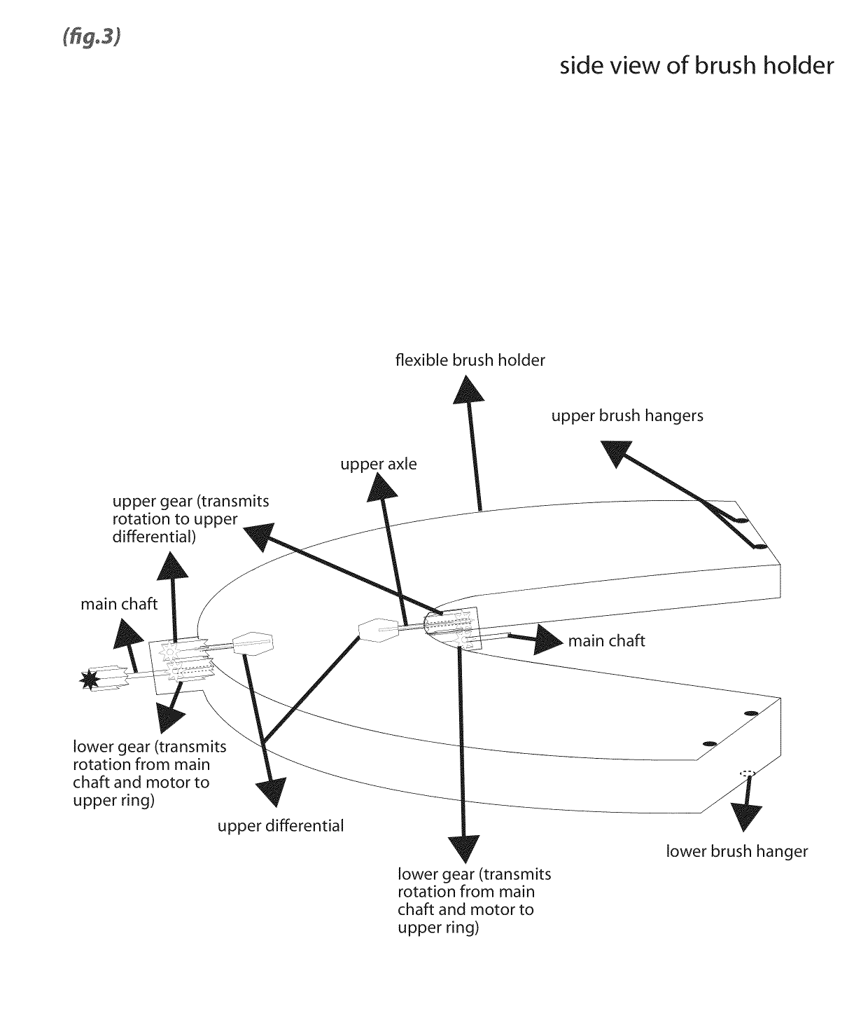

FIG. 4 shows similarities of the differential used in the brush holder and upper axle system and the ones used in mechanics

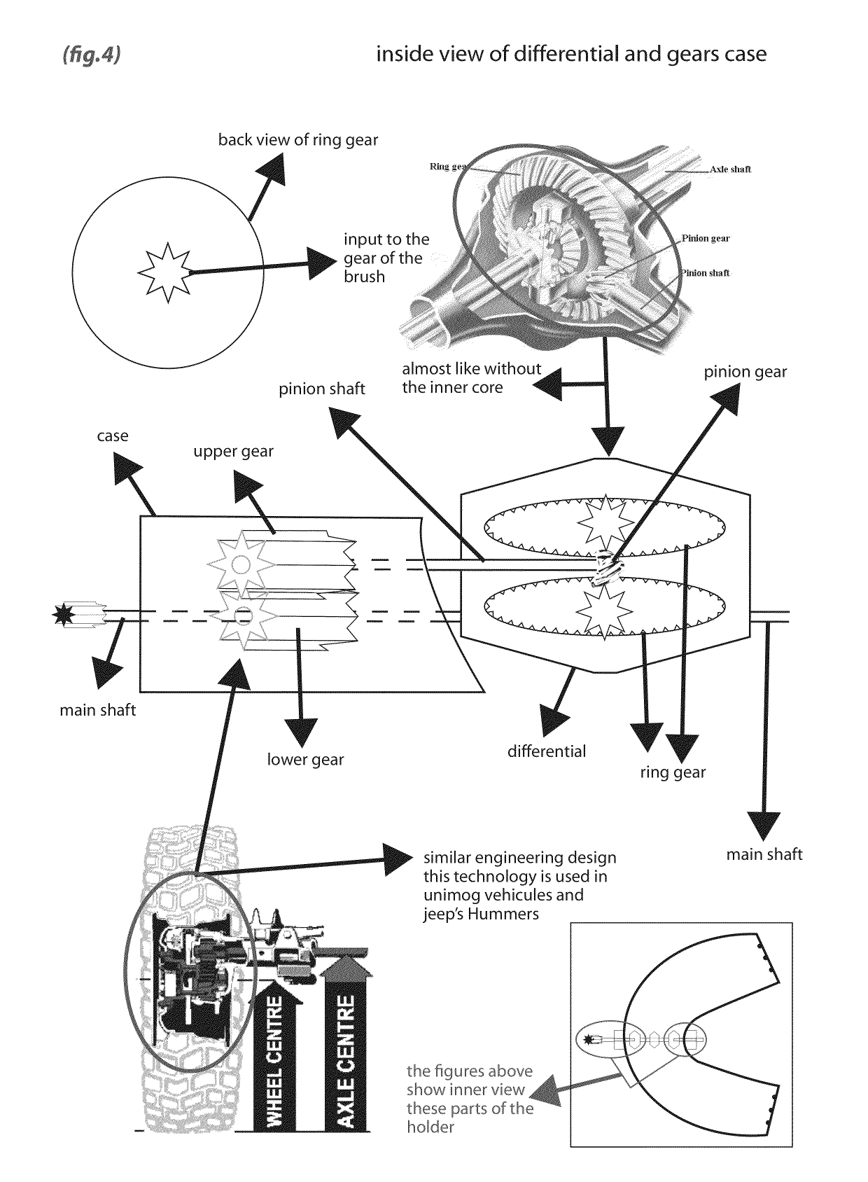

FIG. 5 shows how the main shaft passes through the lower differential

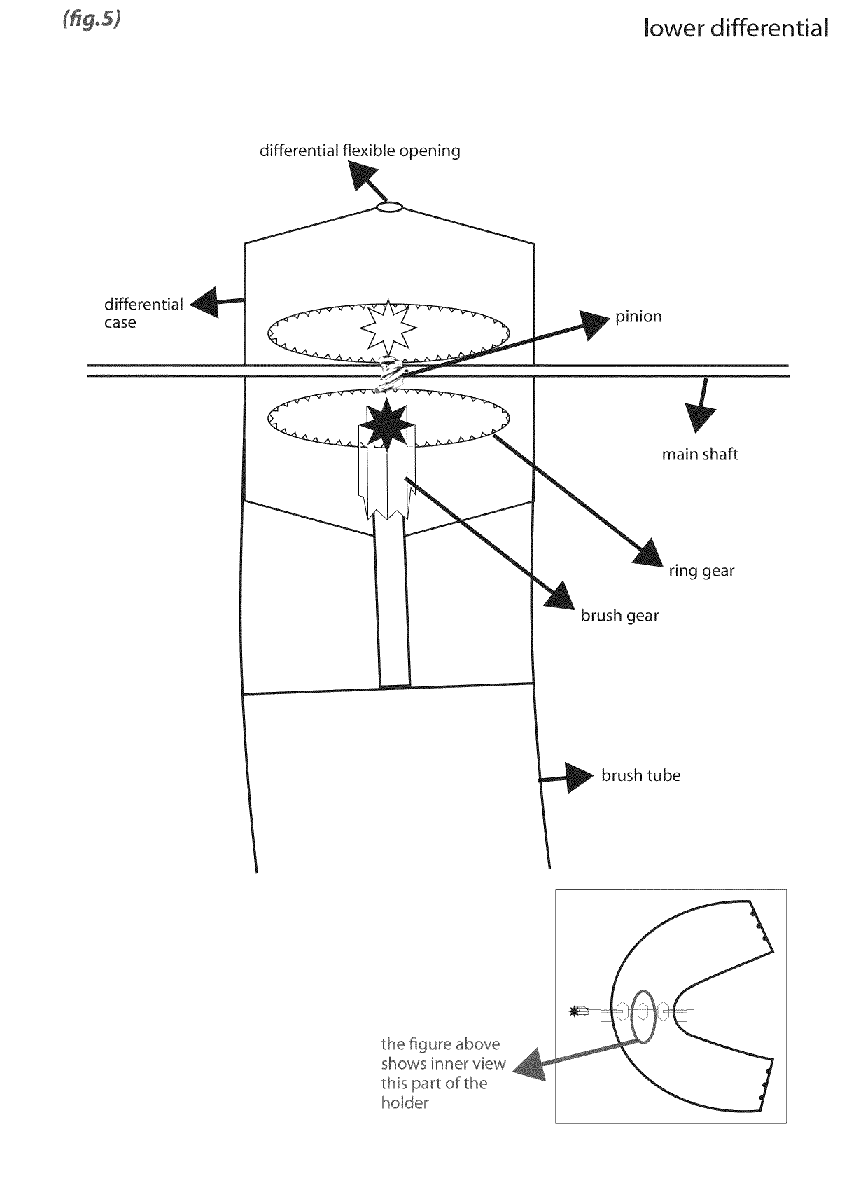

FIG. 6 shows the constitution of a side part of the brush

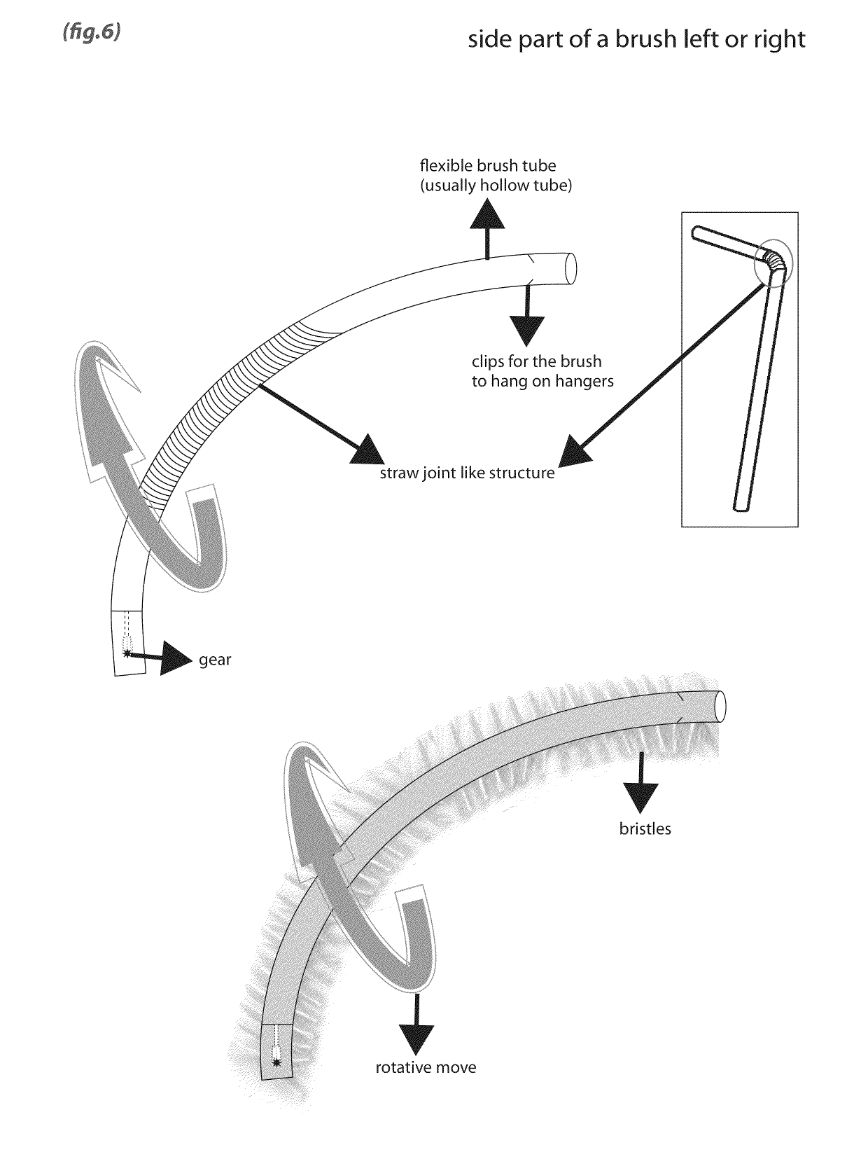

FIG. 7 shows how to side parts of the brush are connected to a differential

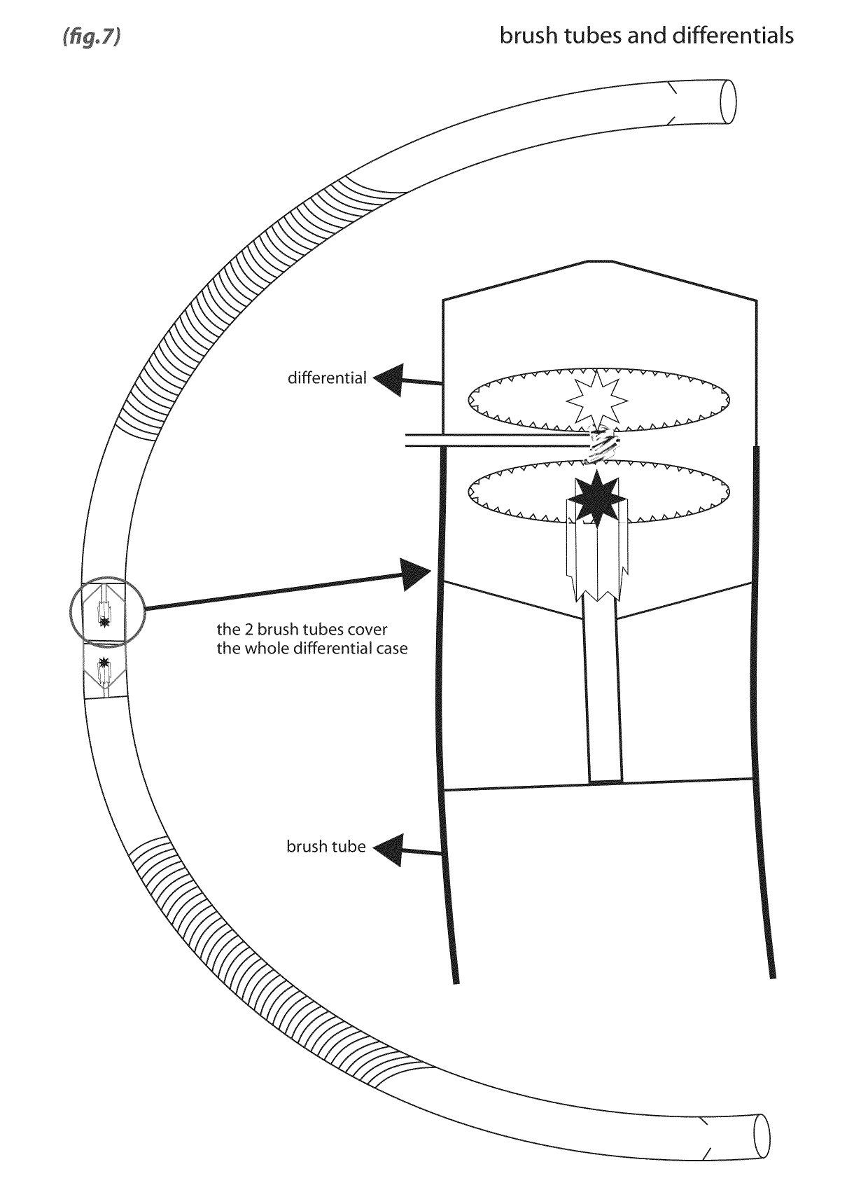

FIG. 8 shows the upper view of the brush holder with brushes fixed on it (due to graphics, the 3 brushes look on the same level but in the real model the middle brush is lower than the 2 others)

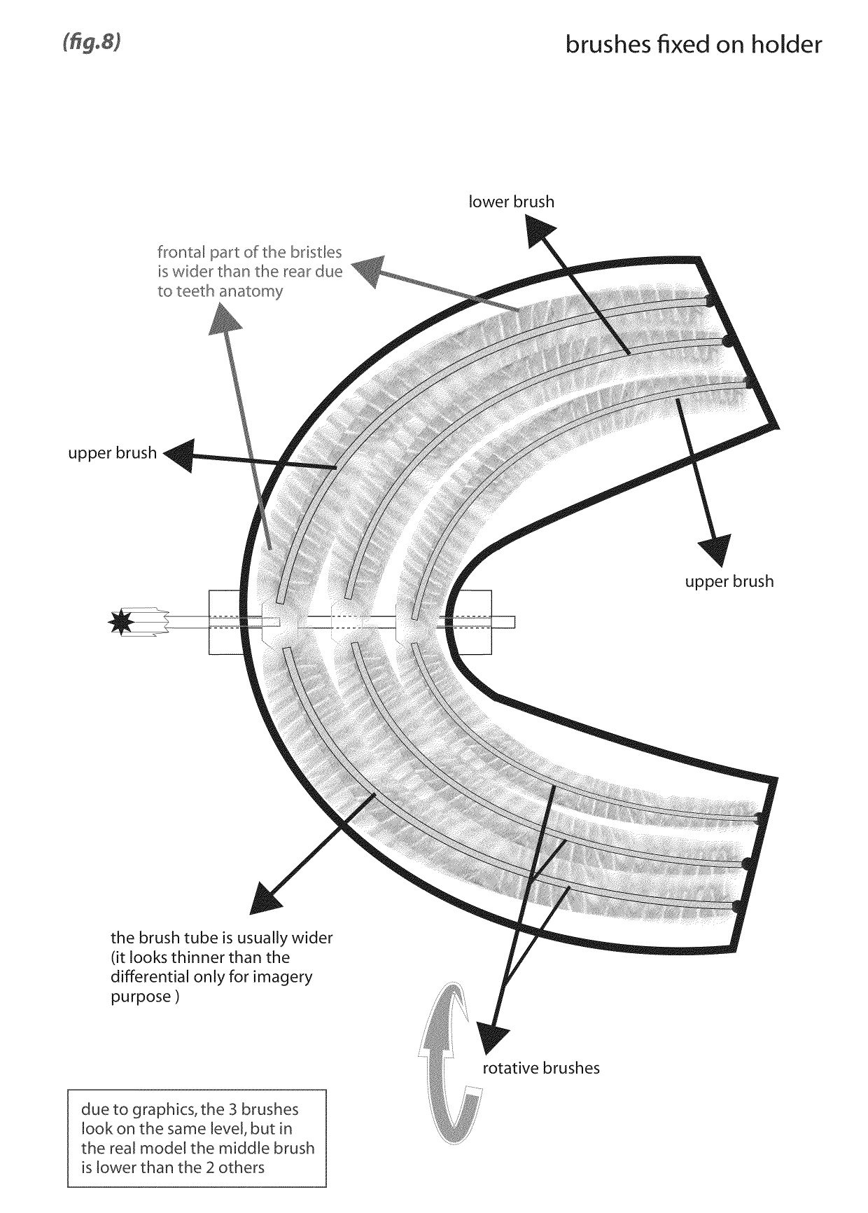

FIG. 9 shows the side view of the brush holder with brushes fixed on it (lower brush is not shown since it sits beneath the two upper ones)

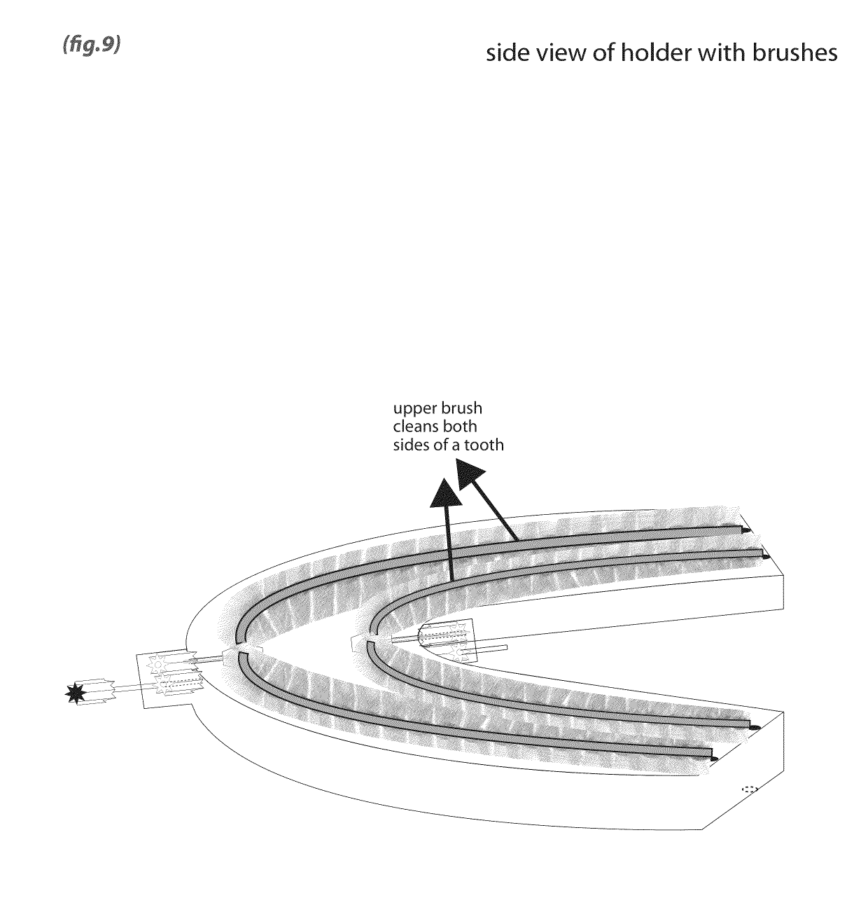

FIG. 10 shows the tongue cleaner fixed on the back of the brush holder

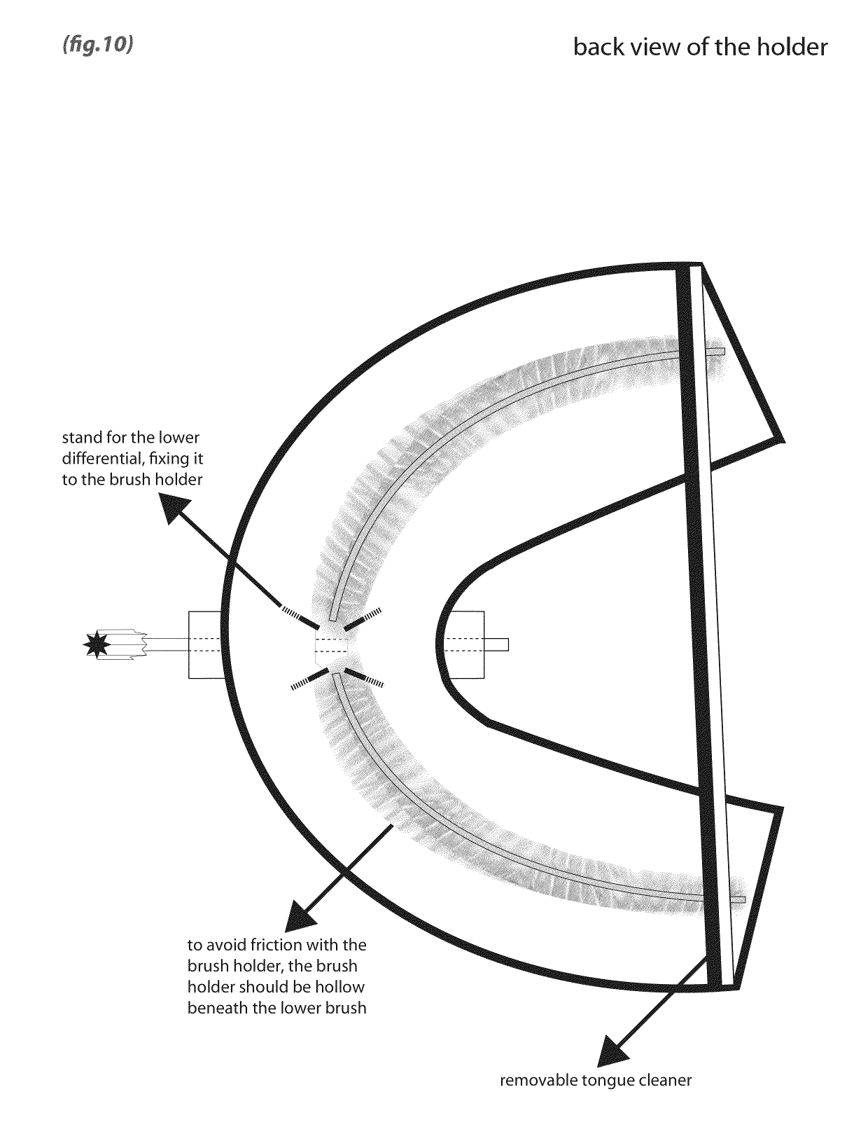

FIG. 11 gives a view of the final product

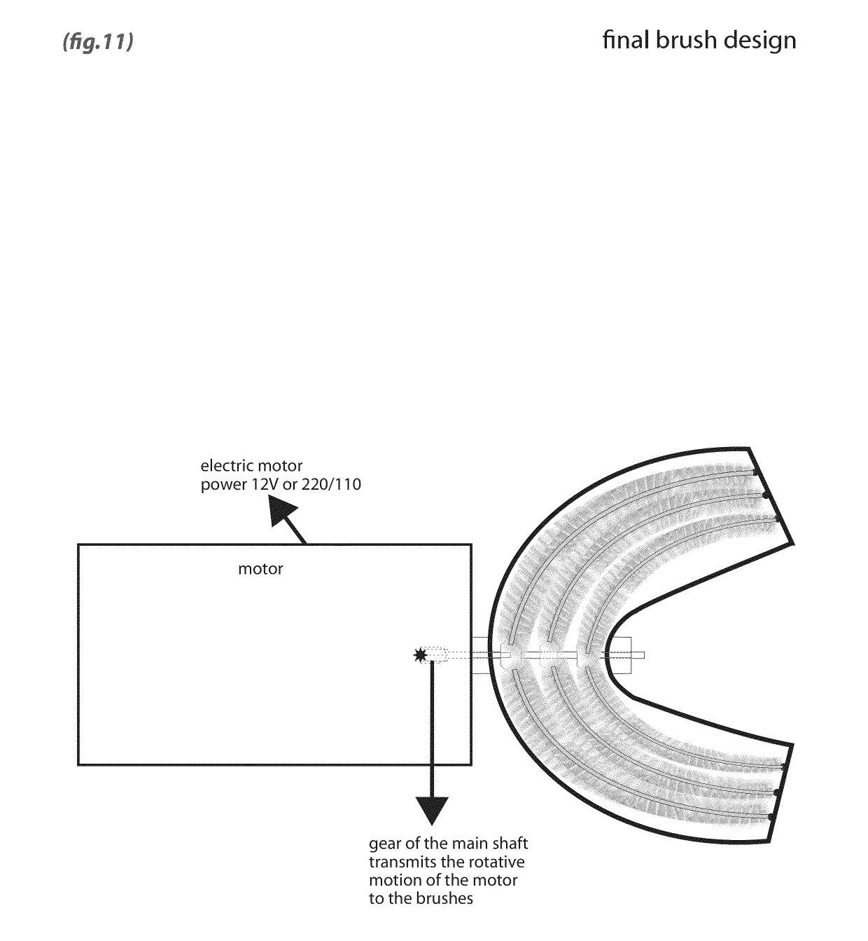

FIG. 12 shows how the electric toothbrush can be used for lower or upper jaw by a simple flip

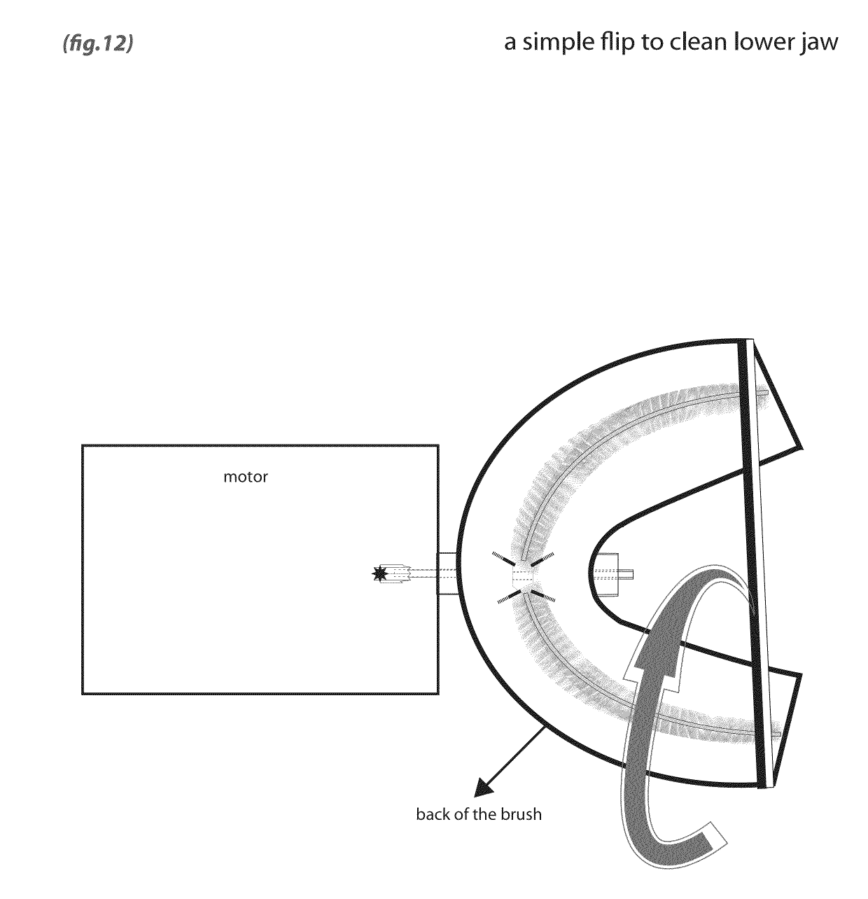

1. With its new design this toothbrush can brush your teeth or the teeth of a mammal only in few seconds.
The average 3 minutes spent for properly brushing someone's teeth will be reduced to around 30 seconds at most. In fact usually for every brushing action, we clean 2 tooth at average with each brush stroke. The total amount of time spent on strokes is about 3 minutes=180 seconds. So by simple calculation, an average of 10 seconds of time is spent on every tooth to be brushed. (180 seconds on every 32 tooth mouth, 2 tooth by brush stroke cleaned).
So for the brushing of an upper jaw a maximum of 15 seconds is needed. The same 15 seconds max. also needed for the lower jaw. To clean the lower jaw the device should be turned over downward.

2. The simplicity, the ease of use, and the time gaining that this device offers to people, encourages them to more frequently brush their teeth and so they'll give more care to their mouth health. It's also equipped with a tongue cleaner.

3. Lots of people catch diseases because of an unhealthy mouth. Actually many new researches found that many cardiologic health problems, digestive disorders, and cancers are caused or affected directly by unhealthy buccal status.
